(19) United States
(12) Patent Application Publication
(10) Pub. No.: US 2002/0103868 A1
(43) Pub. Date: Aug. 1, 2002

(54) Computer system and method for remotely checking mail receptacle content

(76) Inventor: Salman K. Khan, Irvine, CA (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/772,240

(22) Filed: Jan. 29, 2001

(51) Int. Cl. G06F 15/16; G08B 13/14

(52) U.S. Cl. 709/206; 340/569

(57) ABSTRACT

A method for enabling a user of a mail receptacle to remotely receive information relating to the content, if any, of such mail receptacle includes the steps of generating status information for the mail receptacle, the status information including information indicating whether the mail receptacle contains one or more mail items, storing the status information in a computer system, and providing the status information to the user via the computer system, whereby the user can determine from a location spatially remote from the mail receptacle whether the mail receptacle contains the one or more mail items. Preferably, the generating step includes generating information indicating the number of mail items delivered to the mail receptacle, the class of one or more mail items, the sender of one or more mail items, and/or approximately when the one or more mail items will be delivered to the mail receptacle. The computer system is preferably connected to a computer network, such as the World Wide Web, through which users may conveniently receive their mail status information via email and/or by accessing a Web site through which the status information is available. The computer system and method are suitable for use with all types of mail.

### FIELD OF THE INVENTION

The present invention relates generally to a computer system and method for enabling individuals to remotely receive information regarding the contents, if any, of their mail receptacles, and more particularly to such a system and method where status information for multiple mail receptacles is generated and stored in a computer system, and then provided to mail receptacle users via the computer system.

### BACKGROUND OF THE INVENTION

A variety of devices and systems are known in the art for signaling individuals when mail is placed in their mailboxes, thereby enabling such individuals to remotely determine whether their mailboxes contain mail without ambulating to the mailbox and manually inspecting its content, if any. Typically, a detector is placed in or about the mail receptacle to sense the presence or delivery of mail. For example, it is known to use a pressure sensor on the floor of a mailbox to detect the presence of mail through its weight, or to sense when the door of a mail receptacle has been moved or opened, thereby suggesting that mail has been delivered. It is also known to use a detector within a mailbox to detect the presence of “special mail” which contains a magnetic object for facilitating such detection. Regardless of how the mail is detected, the known devices and systems ordinarily signal the mailbox user of the new mail delivery by way of signal lights and/or audible alarms found on a control panel mounted in the user's home, through use of automated phone announcements, etc. In this manner, the mailbox user can avoid needless trips to an empty mailbox, and can promptly retrieve his or her mail from the mailbox immediately upon delivery, if desired.

Though useful, the existing devices and systems in this field are limited in several respects. For example, by requiring special detectors, transmitters, receivers and/or control panels, these systems are frequently cumbersome and costly to install and maintain. Additionally, some of these systems are useful with only special types of mail, as noted above, and require such mail to identified as such in advance. The information provided by such systems is also limited, in that it merely indicates whether the mail receptacle door has been moved, or whether one or more mail items have been placed in the mail receptacle.

As recognized by the inventor hereof, what is needed is a system for providing mail receptacle users with information relating to the contents of their mailboxes, where such information can be conveniently stored and provided to users on demand and/or as it is generated. Such a system would preferably by useful with all types of mail, and would preferably provide users with detailed status information in addition to whether a particular mail receptacle contains mail.

### SUMMARY OF THE INVENTION

In order to solve these and other needs in the art, the present invention enables individuals to remotely and conveniently receive status information relating to the content of their mail receptacles via a computer system in which the status information is stored. The computer system is preferably connected to a computer network, such as the World Wide Web, through which users may conveniently receive their mail status information via email, by accessing a Web site through which the status information is available, or otherwise. By utilizing business and/or personal computers and networks already in use, the invention can be implemented with a minimum of expense, and without requiring purchase and installation of various costly equipment. The invention is also amenable to use with all types of mail, without requiring “special mail” to be identified in advance by the sender or otherwise. Preferably, the status information includes information in addition to that indicating whether a mail receptacle contains one or more mail items. For example, according to present invention, the status information may also indicate the number of mail items included in a mail delivery, the class of one or more mail items (e.g., first class mail, Express mail, etc.), the sender of such mail items, the anticipated time of delivery of such mail items, etc. Moreover, the user is preferably permitted to identify the type of mail items for which status information and/or notifications should be generated.

The invention is particularly useful for leased mail receptacles clustered in central locations, such as traditional post office boxes residing in U.S. Postal Service (“USPS”) facilities, as well mail receptacles leased through private commercial establishments specializing in shipping and packaging, such as Mail Boxes Etc. As provided by the invention, an operator or mail carrier can manually inspect a group of mail receptacles on a regular basis (including as new mail is being deposited) and generate status information for storage in the computer system. This can be accomplished, for example, by initially recording status data in a portable handheld computer device, and then transferring such data to the computer system for storage. The invention is also useful for clustered mail receptacles in apartment, condominium and office buildings, as well as with other residential and business mail receptacles, including roadside mail receptacles.

According to one aspect of this invention, a method for enabling a user of a mail receptacle to remotely receive information relating to the content, if any, of such mail receptacle includes the steps of generating status information for the mail receptacle, the status information including information indicating whether the mail receptacle contains one or more mail items, and storing the status information in a computer system. This method also includes the step of providing the status information to the user via the computer system, whereby the user can determine from a location spatially remote from the mail receptacle whether the mail receptacle contains the one or more mail items. The providing step may be performed, for example, by sending the status information to the user via email, by allowing the user to access the status information on demand via a Web site, etc. Preferably, the generating step includes generating information indicating the number of mail items delivered to the mail receptacle, the class of one or more mail items, the sender of one or more mail items, and/or approximately when the one or more mail items will be delivered to the mail receptacle.

In another aspect of the invention, a method for enabling mail receptacle users to remotely receive information relating to the contents, if any, of their mail receptacles includes the steps of: generating status information for each of a plurality of mail receptacles, each mail receptacle having at least one user associated therewith, the status information for each mail receptacle including information indicating whether such mail receptacle contains one or more mail items; storing the status information for the plurality of mail receptacles in a computer system; and providing the status information for each mail receptacle to its associated user via the computer system, whereby each user can determine from a location spatially remote from its associated mail receptacle whether such mail receptacle contains the one or more mail items.

In yet another aspect of the invention, a computer system includes a memory device in which status information for each of a plurality of mail receptacles is stored. Each mail receptacle has at least one user associated therewith, and the status information for each mail receptacle includes information indicating whether such mail receptacle contains one or more mail items. The computer system is configured for providing the status information for each mail receptacle to its associated user, whereby each user can determine from a location spatially remote from its associated mail receptacle whether such mail receptacle contains one or more mail items.

In still another aspect of the invention, a method for enabling a user to remotely receive information relating to mail to be delivered to the user includes the steps of: generating status information for the mail to be delivered, the status information including information indicating the number of items; storing the status information according to user in a computer system; and providing to the user access to the status information via the computer system, whereby the user can determine information about the mail to be delivered to the user.

Other advantages and features of the present invention will be in part apparent and in part pointed out hereinafter.

### BRIEF DESCRIPTION OF THE DRAWINGS

FIG. 1 is a flow diagram illustrating a method according to one embodiment of the invention for enabling a mail receptacle user to remotely receive information relating to the content, if any, of such mail receptacle.

FIG. 2 illustrates an exemplary email notice through which a variety of mail status information is provided to the user.

FIG. 3 is a block diagram of a computer system implemented according to another embodiment of the invention.

Corresponding reference characters indicate corresponding features throughout the several views of the drawings.

### DETAILED DESCRIPTION OF PREFERRED EMBODIMENTS

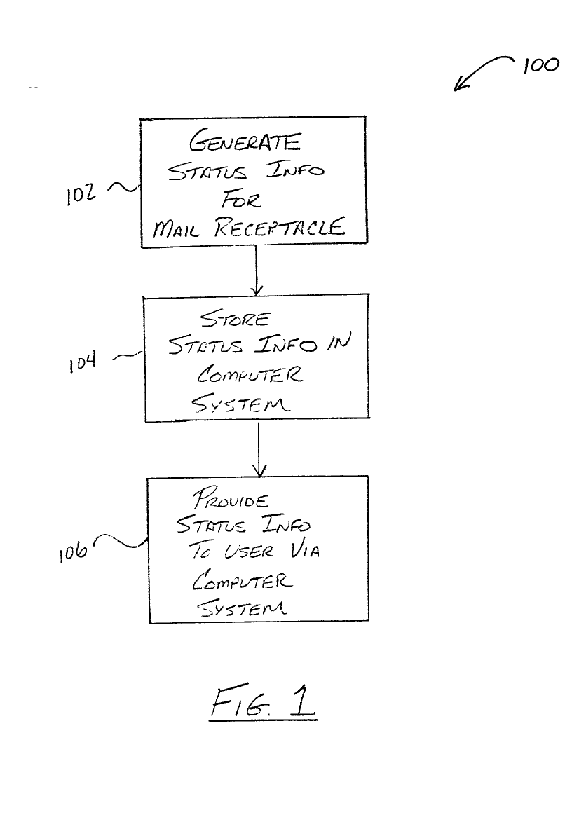

A preferred method for enabling a user of a mail receptacle to remotely receive information relating to the content, if any, of his or her mail receptacle is illustrated in the flow chart of FIG. 1 and indicated generally by reference character 100. The method 100 includes the step, represented by block 102 of FIG. 1, of generating status information for the mail receptacle, including information indicating whether the mail receptacle contains one or more mail items. The method 100 then proceeds with the steps of storing the status information in a computer system, as represented by block 104, and providing the status information to the mail receptacle user via the computer system, as represented by block 106. In this manner, the user can determine from a location spatially remote from the mail receptacle whether the mail receptacle contains the one or more mail items.

As noted above, the status information includes, at minimum, information indicating whether the mail receptacle contains the one or more mail items. Based on this information, the user can decide, for example, whether to postpone or expedite a trip to the mail receptacle (e.g., by the user or an employee of the user) for the purpose of retrieving such mail items. More preferably, however, the status information may include other types of information of potential interest to the user, such as the number of mail items delivered to the mail receptacle, the class (e.g., Express Mail, Priority Mail, first class, third class, etc.) of one or more mail items, the sender of one or more mail items, and/or the time of delivery of one or more mail items. In one embodiment of the invention, the time of delivery information may include information indicating the anticipated time of delivery of one or more mail items, thereby allowing the user to determine whether and when one or more mail items will be delivered to the mail receptacle. Thus, according to the present invention, the user can obtain information about mail items even before such items are delivered to the user's mail receptacle.

The user is preferably allowed to identify in advance the type of status information he or she desires to receive, which may include identifying certain mail items for which no status information is desired. For example, the user may desire status information indicating the total number of all mail items presently held in the mail receptacle, the total number of all mail items except third class mail included in the most recent delivery to the mail receptacle, the sender's identity for all Express Mail items except those sent by ABC Corporation, and/or the time of delivery for all Express Mail and Priority Mail items. From this exemplary list of status information, it should be clear that a wide variety of status information is preferably available to the user, and the user can preferably exercise control over what status information is generated so as to best meet the user's needs without burdening the user with potentially unwanted information.

Preferably, the computer system referenced in blocks 104, 106 of FIG. 1 is connected to a computer network (such as an internet, intranet, extranet, local area network or wireless network, or any combination thereof), and preferably the World Wide Web, through which the user can remotely receive the status information. This may be accomplished through use of electronic mail (e.g., email) messages sent periodically or upon the occurrence of certain events. For example, the computer system in which the status information is stored can be configured to email the user each time the status information for the user's mail receptacle is updated, which may occur each time new mail items are delivered to the mail receptacle. The electronic message may simply inform the user that updated status information is available, thereby prompting the user to independently access the updated status information, such as through a World Wide Web site as described below. More preferably, however, the updated status information will be included in the electronic message for immediate review by the user. As should be apparent, such electronic messages can be received by the user through any appropriately configured device, including a desktop or laptop computer, a PDA device, a wireless phone, etc.

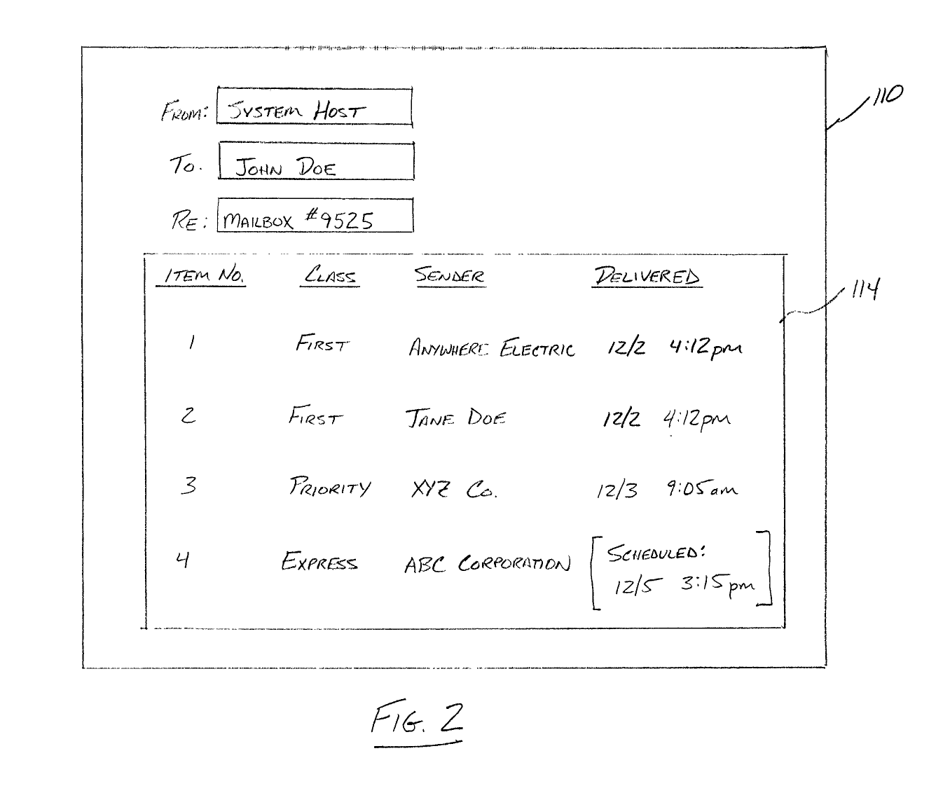

An exemplary email message containing status information according to the present invention is provided in FIG. 2. As shown therein, the message 110 is from the “system host” (i.e., the aforementioned computer system) to a representative user, “John Doe,” and relates to the user's mail receptacle, identified in this example as “Mailbox 9525.” In this particular example, the message includes a message box 114 in which information is provided for each of four separate mail items delivered (or to be delivered) to the user's mail receptacle, including information identifying the number of mail items (four, in this case), the class of each mail item (i.e., first, Express or Priority), the name of the sender for each mail item, and the delivery time of each mail item. For item number four, the “scheduled” delivery time is provided, thus indicating that the item has not yet been delivered, while notifying the user in advance as to approximately when delivery of this mail item can be expected. As should be apparent, the message 110 shown in FIG. 2 is intended to be exemplary only, and could be configured in numerous other ways and embody more or less status information of the same and/or different types as that illustrated in FIG. 2.

Preferably, the computer system referenced in blocks 104, 106 of FIG. 1 also hosts a World Wide Web site (or a suitable site on another computer network) through which the status information can be accessed by the user on demand. Upon logging in to the site by providing, for example, a user ID and password, and perhaps a “mailbox ID” as well, the status information for the user's mail receptacle is preferably displayed in a form not unlike that used in the exemplary message 110 of FIG. 2. Preferably, the computer system or associated Web site also supports the electronic messaging functionality described above. In this manner, the user would not only have at least two different options for receiving the status information, but the user can preferably choose to limit the circumstances under which email notifications are used, if at all. For example, in the case where all status information for the user's mail receptacle is accessible through the Web site, the user may choose to receive email notifications only when status information is generated with respect to Express Mail, but not other, items.

Although in the embodiment under discussion, the user can preferably receive the status information via both email notifications (in which the status information is preferably embodied) as well as on demand via the Web site, those skilled in the art will recognize that status information can be provided to the user via the computer system in other ways (e.g., through dial-up connections, distributed software applications, Web alerts, voice messaging, pagers, etc.) without departing from the scope of the invention.

Referring again to block 102 of FIG. 1, the status information can be generated in many different ways, all of which are included within the scope of the invention. The status information can be generated manually by a human operator, preferably with the assistance of a personal computer device in which status data can be conveniently stored and then transferred to the host computer system. As an example, an operator can manually inspect the user's mail receptacle and then, based on such inspection, record status data in a handheld computer via a suitable input device such as a keyboard, keypad, stylus, etc. In turn, the hand-held computer transfers the recorded data to the computer system for providing the status information to the mail receptacle user. Other devices can also be used for generating the status information including, for example, bar code scanners. An optical camera can also be used to permit remote inspection of the mail receptacle's content. Status information can also be generated automatically using the mail sensing devices and systems of the prior art. As apparent to those skilled in the art, the selection of appropriate sensing equipment will depend in part upon the specific features of the invention to be implemented and the types of status information to be generated.

In many cases, the status information for one or more particular mail items will be generated at or after the time of delivery of such mail. It should be understood, however, that this information may also be generated in advance of delivery, provided that the data on which the status information is based, and from which the status information is generated, can be obtained prior to delivery. As an example, status information can be generated from an automatic mail reader or sorter used at a point of process in a mail delivery system. In one embodiment of the information, this status information indicates the number of mail items that will be delivered to the user, and this information is preferably forwarded to the user by email in advance of delivery. In this manner, the user can preferably determine in advance whether, for example, it should expect any packages from an overnight delivery service.

Note that in the above and certain other embodiments of the invention, the mail recipient is not required to possess or use a mail receptacle. It should therefore be understood that the present invention is not limited solely to use with mail receptacles, or with conventional mail of the type that is delivered only by the USPS to mail receptacles. Rather, the invention is useful with all types of shipped items, packages and articles.

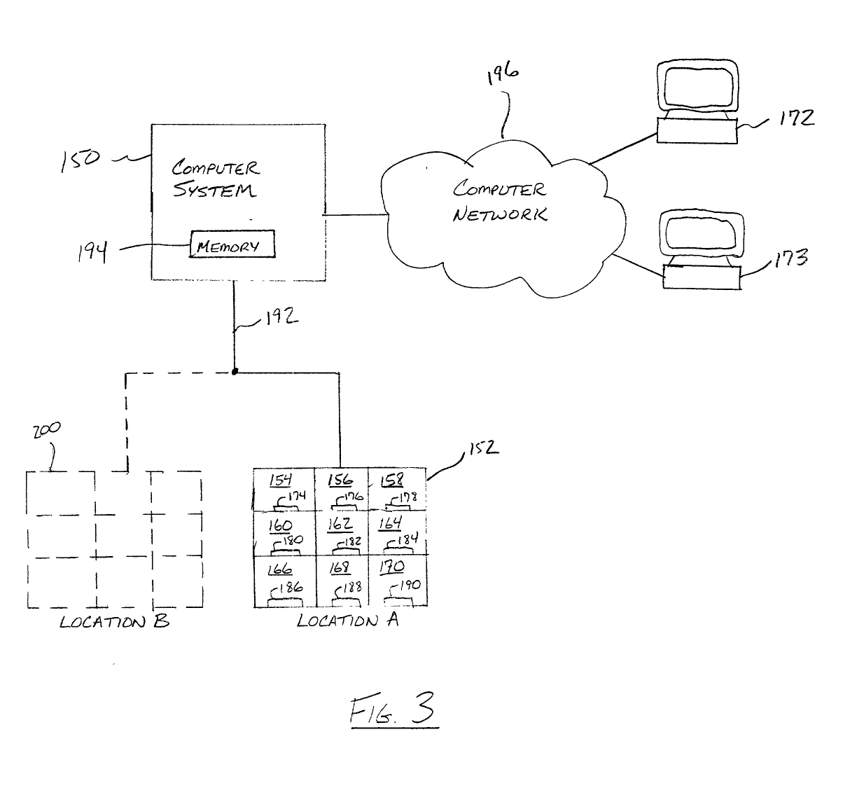

Although thus far the invention has been described in detail only with reference to a single mail receptacle and its associated user, it should be understood that the teachings of the invention can be applied to an entire group (or several groups) of mail receptacles including, in particular, “clustered” mail receptacles (i.e., conventional Post Office boxes and similar mail receptacles available, typically by lease, from commercial shipping and packaging centers such as Mailboxes Etc. offices). An example of such an implementation is illustrated in FIG. 3 and includes a computer system 150 (which may itself comprise one or more computers in one or more locations), a grid 152 of clustered mail receptacles, which includes individual mail receptacles 154-170, and two exemplary user computers 172, 173. Each mail receptacle 154-170 has a mail detector device 174-190 associated therewith to facilitate the automatic detection of mail deliveries. As noted above, a variety of such detectors are already known in the art and will therefore not be described in detail here. The mail detector devices 174-190 are preferably connected to the computer system 150 over a communication link 192, which may be a wired or wireless link, for transferring mail status information (of any one or more types described herein) generated by the detector devices 174-190 to the computer system 150 for storage in memory 194. Alternatively, the status information could be manually generated by an operator and then transferred to the computer system 150, as described above.

As shown in FIG. 3, the user computers 172, 173 are preferably connected to the computer system 150 through a computer network 196 which, in one preferred implementation, is the World Wide Web. Note that computer network 196 may also serve as the aforementioned communication link 192 that connects the mail detector devices 174-190 to the computer system 150. Preferably, the status information stored in memory 194 is provided to the appropriate users via the computer network 196 and the user computers 172, 173, such as by email and/or through a World Wide Web site hosted by the computer system 150, as noted above. In a case where the status information is not limited to information indicating whether a particular mail receptacle contains mail, each user can preferably control the type of status information that is generated for that user's mail receptacle, as well as the events that trigger the sending of email notices to that user.

In addition to providing or notifying users of new status information, it should be recognized that the email notices mentioned above (or separately generated email notices) can be utilized as part of a messaging service and/or to provide informative notices to the users. The computer system may also be configured to send electronic billing notices to users, through the computer network or otherwise, to serve as invoices for services provided to the user. For example, if a user is leasing his or her mail receptacle, the electronic billing notice may represent an invoice for that service.

Although only nine mail receptacles and their associated detectors are included in the exemplary grid 152 of FIG. 3, it should be understood that such grid could comprise substantially more or less mail receptacles and detectors without departing from the scope of the invention. Similarly, while only two user computers 172, 173 are shown in FIG. 3, it should be recognized that each mail receptacle will have at least one associated user, and each user may have one or more computer devices connected to the computer network 196 for the purpose of, among other things, receiving status information from the computer system 150. Furthermore, although the user computers 172, 173 are depicted in FIG. 3 as desktop computers, those skilled in the art will recognize that other types of computer devices can be employed.

Illustrated in phantom in FIG. 3 is a second optional grid 200 of clustered mail receptacles positioned at a Location B that is geographically remote from Location A where the first grid 152 of mail receptacles is located. In accordance with the present invention, status information for the second grid 200 of mail receptacles may be transferred over the communication link 192, or another link, to computer system 150 for storage in memory 194 along with the status information for the first grid 152 of mail receptacles. For example, in the case of a business having multiple offices with leased mail receptacles in each office, the status information for all such mail receptacles may be conveniently stored and managed in the computer system 150. Preferably, the computer system 150 also hosts the business' Web site, and is configured to permit all of its customers to access their mail status information through that single Web site, regardless of the particular offices where such users' mailboxes may be located.

In addition to providing mail status information as described above, according to the present invention, the computer system may be configured to also provide historical usage reports for each of the mail receptacles 154-170, either at the request of the appropriate user, on a regular basis (e.g., monthly or quarterly), or both. Such reports are preferably derived from historical status information stored in the computer system 150, and preferably report specific information requested by the user, such as the number of mail items delivered to the user's receptacle for the period in question, the number of such mail items broken down by class, etc. Where desirable, a combined report for multiple mail receptacles (e.g., a group of mail receptacles leased by a single company or individual) can also be produced.

As should be apparent, “mail receptacle” as used herein includes any type of mailbox, container, tray or space where an individual or entity regularly receives mail deliveries. “Mail” or “mail item” as used herein includes any type of item, package or article shipped (or in the process of being shipped) from one location to another via a delivery or courier service.

When introducing elements of the present invention or the preferred embodiments thereof, the articles “a”, “an”, “the” and “said” are intended to mean that there are one or more of such elements. The terms “comprising”, “including” and “having” are intended to be inclusive and mean that there may be additional elements other than the listed elements.

As various changes could be made in the methods and systems described above without departing from the scope of the invention, it is intended that all matter contained in the above description or shown in the accompanying drawings shall be interpreted as illustrative and not in a limiting sense.

What is claimed is:

1. A method for enabling a user of a mail receptacle to remotely receive information relating to the content, if any, of such mail receptacle, the method comprising the steps of:
generating status information for the mail receptacle, the status information including information indicating whether the mail receptacle contains one or more mail items;
storing the status information in a computer system; and
providing the status information to the user via the computer system, whereby the user can determine from a location spatially remote from the mail receptacle whether the mail receptacle contains the one or more mail items.

2. The method of claim 1 wherein the generating step includes generating information indicating the number of said one or more mail items delivered to the mail receptacle.

3. The method of claim 1 wherein the generating step includes generating information indicating the class of said one or more mail items.

4. The method of claim 1 wherein the generating step includes generating information indicating approximately when the one or more mail items will be delivered to the mail receptacle.

5. The method of claim 1 further comprising the step of permitting the user to identify the one or more mail items for which status information should be generated.

6. The method of claim 1 wherein the computer system is connected in communication with a computer network and the providing step includes permitting the user to receive the status information stored in the computer system through the computer network.

7. The method of claim 6 wherein the computer network is the World Wide Web.

8. The method of claim 6 wherein the providing step includes sending electronic messages from the computer system to the user through the computer network.

9. The method of claim 1 further comprising the steps of updating the status information when one or more mail items are delivered to the mail receptacle and notifying the user when the status information is updated.

10. The method of claim 1 wherein the generating step includes generating the status information using a detection device associated with the mail receptacle.

11. The method of claim 1 wherein the generating step includes manually inspecting the mail receptacle to determine whether it contains the one or more mail items and generating the status information based on the results of the inspecting step.

12. The method of claim 11 wherein the generating step includes recording status data in a portable computer device and the storing step includes transferring the recorded status data from the portable computer device to the computer system.

13. A method for enabling mail receptacle users to remotely receive information relating to the contents, if any, of their mail receptacles, the method comprising the steps of:
generating status information for each of a plurality of mail receptacles, each mail receptacle having at least one user associated therewith, the status information for each mail receptacle including information indicating whether such mail receptacle contains one or more mail items;
storing the status information for the plurality of mail receptacles in a computer system; and
providing the status information for each mail receptacle to its associated user via the computer system, whereby each user can determine from a location spatially remote from its associated mail receptacle whether such mail receptacle contains the one or more mail items.

14. The method of claim 13 wherein the computer system is connected to a computer network and the providing step includes providing the status information for each mail receptacle to its associated user through the computer network.

15. The method of claim 14 wherein the computer network is the World Wide Web.

16. The method of claim 14 wherein the plurality of mail receptacles include a first plurality of clustered mail receptacles at a first location.

17. The method of claim 16 wherein the plurality of mail receptacles include a second plurality of clustered mail receptacles at a second location spatially remote from the first location.

18. The method of claim 16 wherein the generating step includes generating, for each mail receptacle, information selected from the group consisting of: information indicating the number of said one or more mail items delivered to such mail receptacle, and information indicating the class of said one or more mail items.

19. The method of claim 13 further comprising the step of generating the status information using a plurality of detection devices, each detection device being associated with a different one of the mail receptacles.

20. The method of claim 19 wherein the plurality of detection devices are each connected to the computer system through a communication link.

21. The method of claim 13 further comprising the step of sending electronic notices to the mail receptacle users via the computer system.

22. The method of claim 21 wherein the mail receptacles are leased mail receptacles and the electronic notices include electronic billing notices for the leased mail receptacles.

23. The method of claim 13 further comprising the step of generating historical usage reports for each mail receptacle.

24. A computer system having a memory device, the memory device storing status information for each of a plurality of mail receptacles, each mail receptacle having at least one user associated therewith, the status information for each mail receptacle including information indicating whether such mail receptacle contains one or more mail items, the computer system being configured for providing the status information for each mail receptacle to its associated user, whereby each user can determine from a location spatially remote from its associated mail receptacle whether such mail receptacle contains one or more mail items.

25. The computer system of claim 24 wherein the computer system is connected to a computer network and configured for permitting each mail receptacle user to access the status information for its associated mail receptacle through the computer network.

26. The computer system of claim 25 wherein the computer network is the World Wide Web.

27. The computer system of claim 25 wherein the plurality of mail receptacles are clustered mail receptacles.

28. The computer system of claim 27 wherein the clustered mail receptacles are leased mail receptacles and the computer system is configured for sending billing notices for the leased mail receptacles to the associated users through the computer network.

29. A method for enabling a user to remotely receive information relating to mail to be delivered to the user, the method comprising the steps of:
generating status information for the mail to be delivered, the status information including information indicating the number of items;
storing the status information according to user in a computer system; and
providing to the user access to the status information via the computer system, whereby the user can determine information about the mail to be delivered to the user.

30. The method of claim 29 wherein the generating step includes generating the status information as the mail to be delivered to the user is sorted.

31. The method of claim 30 wherein the providing step includes sending the status information to the user via email.

32. The method of claim 1 wherein the generating step includes generating the status information at a point of process in a mail delivery system.
